(19) United States
(12) Patent Application Publication
(10) Pub. No.: US 2005/0063684 A1
(43) Pub. Date: Mar. 24, 2005

(54) Speed controlling method for an electric motor, control circuit and electric motor

(75) Inventor: Dieter Moser, (US)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/920,411

(22) Filed: Aug. 18, 2004

(30) Foreign Application Priority Data
Sep. 18, 2003 (EP) 03360106.3

(51) Int. Cl. H02P 5/06

(52) U.S. Cl. 388/804

(57) ABSTRACT

The invention relates to a method for controlling the speed and/or the position of an electric motor, comprising the steps of generating a first digitally pulsed signal, whose frequency represents the desired speed of the motor, deriving a second signal which represents the speed and/or the position of the motor, deriving a control signal out of a result of a comparison of said first signal to said second signal, controlling the speed and/or the position of the motor by applying said control signal to the motor, wherein said second signal is a digitally pulsed signal derived by encoding the motor speed and said comparison is made by subtracting the number of pulses of said first from the number of pulses of said second signal or vice versa and a control circuit for controlling an electric motor according to the method.

### BACKGROUND OF THE INVENTION

The invention is based on a priority application EP 03360106.3 which is hereby incorporated by reference.

The invention relates to a speed controlling method for an electric motor, a control circuit and an electric motor. The method for controlling the speed and/or the position of the electric motor is comprising the steps of generating a first digitally pulsed signal, whose frequency represents the desired speed of the motor; deriving a second signal which represents the speed and/or the position of the motor; deriving a control signal out of a result of a comparison of said first signal to said second signal and controlling the speed and/or the position of the motor by applying said control signal to the motor.

An example for a digital speed control of an electric motor is given in “Digital speed control of DC motor” by Sjostedt, J. and Stalberg, N. in IBM Technical Disclosure Bulletin 1981, vol.23, no. 11, p. 5141-5142, wherein a circuit is provided where the motor speed is controlled by a differential amplifier having a first input from a motor tachogenerator and a second input from a digitally stepped counter. The amplifier compares and synchronizes the motor speed with the electric frequency of the input signals to the counter. The counter is preset by a digital load value and stepped by a clock pulse. This analog solution is built out of a frequency to voltage converter and an analog speed control. The revolutions of the motor are detected by a sensor and converted through a frequency to voltage converter into a voltage that is applied to an analog speed controller.

In EP 0776 082 B1 an electrical machine system with power control for brushless motors, having a digital stator-rotor position sensor, e.g. a disk and hall effect pick-up to give a digital output, is enclosed. The output of the sensor is provided to an interface unit which provides data to a motor controller which switches an available power supply.

A disadvantage of the existing digital speed control methods according to the state of the art is that one cannot control zero speed or low speed at e.g. one hundred revolutions per minute (rpm) or below accurately with these methods.

It is therefore an object of the invention to provide a speed controlling method and an electric motor which overcome the problems associated with the related art, in particular which can be used for low speeds.

### SUMMARY OF THE INVENTION

This object is attained by the method for controlling the speed and/or the position of an electric motor, preferably a direct current motor, comprising the steps of
generating a first digitally pulsed signal, whose frequency represents the desired speed of the motor;
deriving a second signal which represents the speed and/or the position of the motor;
deriving a control signal out of a result of a comparison of said first signal to said second signal;
controlling the speed and/or the position of the motor by applying said control signal to the motor, wherein a said second signal is a digitally pulsed signal derived by encoding the motor speed and said comparison is made by subtracting the number of pulses of said first from the number of pulses of said second signal or vice versa.

Further advantageous features of the invention are defined in the depending claims.

The method is comprising the steps of
generating a first digitally pulsed signal, whose frequency represents the desired speed of the motor;
deriving a second signal which represents the speed and/or the position of the motor;
deriving a control signal out of a result of a comparison of said first signal to said second signal;
controlling the speed and/or the position of the motor by applying said control signal to the motor.

According to the invention said second signal is a digitally pulsed signal derived by encoding the motor speed and said comparison is made by subtracting the number of pulses of said first from the number of pulses of said second signal or vice versa.

By applying the inventive method a good speed control at low speed and a position control at e.g. one hundred pulses per revolution or less is achieved by using an encoder, which is well known and at low cost. Good motor behaviour at low and zero speed is the result. The inventive method is easily realised, as the different steps of the method can be performed using well known elements.

Preferably, the method is applied to control a direct current motor, especially a brushless motor. Brushless motors need the detection of the actual states. Hence they have an immanent encoder as a position sensor, which can be used to derive the signal which represents the speed and/or the position of the motor.

Preferably, the subtraction is made by counting a digital counter in the directions up and down, wherein the pulses of the first signal are counted in the opposite direction than the pulses of the second signal. In this case the counter value can be used directly to generate the control signal. The counter stays at a predefined value, e.g. zero, in an adjusted state, meaning the motor is running at the desired speed. If the counter value (control error) differs from this value the difference can easily be translated into the control signal.

Preferably, the control signal is pulse width modulated according to the result of said subtraction. Due to pulse width modulation of a voltage of the motor's power supply a good motor performance can be achieved.

In another embodiment of the invention a control loop method is performed, in which the steps according to the inventive method are repeated after a predefined number of pulses of at least one of said signals has passed. Preferably, the number of pulses is corresponding to one revolution of the motor. If only the speed of the motor has to be controlled, it is not the number of pulses since the motor has been started that has to be compared to the number of pulses of the generated signal, but only the number of pulses in a predefined interval of time or pulses. So the counting of the number of pulses can be restarted or repeated after a predefined number. If the absolute position of the motor has to be controlled, the total number of pulses has to be counted.

According to another embodiment of the invention a control circuit which is able to perform the inventive method, preferably comprising a microprocessor for controlling the speed and/or the position of an electric motor, preferably a direct current motor, is provided. The control circuit is comprising a pulse generator for generating a digitally pulsed first signal, whose frequency represents the desired speed of the motor, input means for a second signal which represents the speed and/or the position of the motor, means for deriving a control signal from an output of comparing means designed to compare said first signal to said second signal and output means being designed to output said control signal to the electric motor and/or a power supply of the motor for controlling the speed and/or the position of the motor, wherein said input means for said second signal are designed to receive a digitally pulsed signal whose frequency is an encoding of the motor speed and said comparing means are designed to subtract the number of pulses of said first from the number of pulses of said second signal or vice versa.

The control circuit can be attached to any electric motor to enable speed and/or position control according to the invention to achieve the advantages of the inventive method.

Preferably, said comparing means are comprising a digital up and down counter being designed to count in the directions up and down and being designed to subtract the number of pulses of said first from the number of pulses of said second signal or vice versa by counting the number of pulses of the first signal in the opposite direction than the pulses of the second signal. Using a digital up and down counter to perform the subtraction is a cheap and easy solution to compare two digitally pulsed signals.

In the inventive control circuit said means for deriving a control signal are preferably comprising a pulse width generator being designed to modulate a pulse width of the control signal according to a result of said subtraction. Controlling the speed and/or the position of an electric motor by using a pulse width generator as power supply results in a good motor performance.

The inventive control circuit preferably is comprising control loop means being designed to repeat the controlling and/or carrying out of the steps of the inventive method after a predefined number of pulses of at least one of the signals have passed. This embodiment is used advantageously to control the speed, regardless of the position of the electric motor.

According to the invention, the object concerning an electric motor, preferably a direct current motor, is achieved by an electric motor comprising a sensor for generating a digitally pulsed signal having a frequency representing the actual speed of the motor and control signal input means, wherein the electric motor is comprising a control circuit according to the invention, having the pulsed signal generated by the sensor at its input means and having connected its output means to the control signal input means of the motor.

The inventive electric motor preferably is comprising a microprocessor loaded with a computer program with software code sections by which the steps of the method according to the invention are carried out and/or controlled. Programming a microprocessor which is part of the electric motor according to the inventive method is the most appropriate way to achieve the advantages provided by the inventive method.

The different features of the preferred embodiments of the invention may be used in combination together with the invention as set forth in the independent claims or just each single preferred embodiment together with the invention as set forth in the independent claims.

### BRIEF DESCRIPTION OF THE DRAWINGS

The embodiments of the invention will now be described with reference to the accompanying drawing.

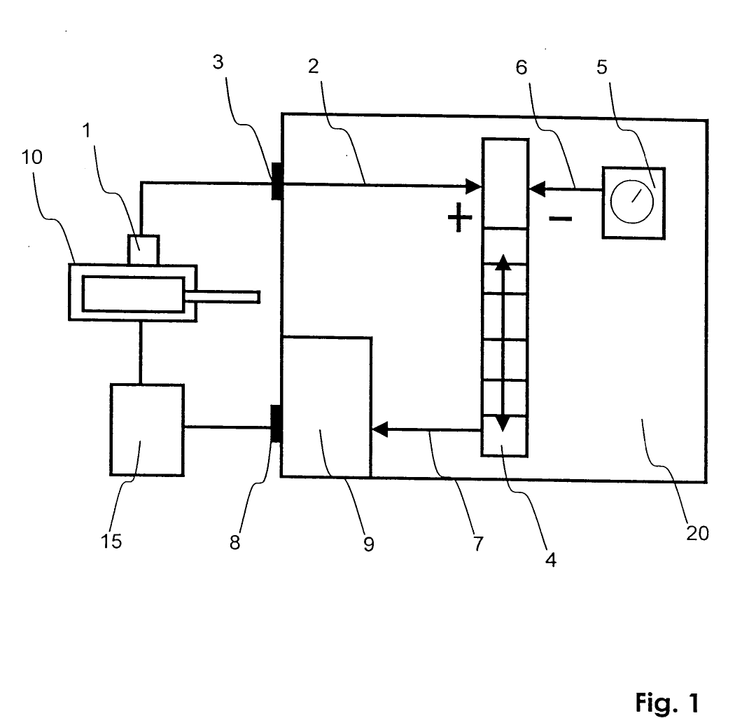

In FIG. 1 an electric motor 10 being controlled by a control circuit 20 according to the invention, which is designed to perform the inventive method, is shown.

Basic idea of the inventive method is to count pulses, which give an actual value of the motor speed and a desired value for the motor speed. They run inversely and charge a counter 4. For example, the pulses 2 (pulse train) representing the actual motor speed are counted up (+) and the pulses 6 (pulse train) generated by the pulse generator 5 are counted down (−). In the adjusted state the counter 4 stays e.g. at zero. The counter reading is used as a control signal 7 for a pulse width modulator 9. The control circuit 20 is comprising a microprocessor having a pulse generator 5, which simulates a digital signal, whose clock matches to the desired speed. Also, the representation of the digital up and down counter 4, the conversion into pulse width modulation and the detection of the actual pulses can be made within the microprocessor. The control circuit 20 is comprising a pulse generator 5 for generating a pulse train 6 representing the desired speed of the motor 10, hence a simulated microprocessor internal signal, which is equivalent to the signal of a sensor 1 (digital encoder) at the desired speed, a control input 3 for a pulse train 2 representing the actual value of the speed, which is measured by a sensor 1, being designed to generate a digital pulsed signal having a frequency representing the actual speed, an up and down counter 4 for comparing both pulse trains 2, 6 and a pulse width generator 9 with a control loop, whose control value is the count of the up and down counter. Furthermore, the control circuit is comprising output means 8 for putting out the frequency modulated signal according to the control signal to the electric motor or rather the power stage 15 of the motor.

The speed- and position control for an electric motor is using an encoder with at least two channels with at least one pulse per revolution, a micro controller and a power stage 15 with pulse width modulation (PWM) input.

First, the step of detecting and recognizing the actual encoder signal pulse train 2 with the microprocessor is performed. Then this signal is compared to a simulated signal pulse train 6 which is equivalent to the signal of the encoder at a desired speed with an up and down counter 4. The actual encoder signal counts up or down, the simulated encoder signal counts in the opposite direction. The counter value is the control error and is directly used to generate the pwm value for the power stage 15. For example, pwm or counter maximum means full speed; e.g. cw, pwm or counter minimum means full speed; e.g. ccw and pwm or counter middle value means no speed.

1. A method for controlling the speed and/or the position of an electric motor, comprising the steps of
generating a first digitally pulsed signal, whose frequency represents a desired speed of the motor;
deriving a second signal which represents at least one of a current speed and current position of the motor;
deriving a control signal out of a result of a comparison of said first signal to said second signal; and
controlling at least one of the speed and the position of the motor by applying said control signal to the motor, wherein said second signal is a digitally pulsed signal derived by encoding at least one of the motor speed and motor position and said comparison is made by subtracting the number of pulses of said first signal from the number of pulses of said second signal or vice versa.

2. The method according to claim 1, characterised in that said subtraction is made by counting a digital counter in the directions up and down, wherein the pulses of the first signal are counted in the opposite direction from the pulses of the second signal.

3. The method according to claim 1, characterised in that said control signal is pulse width modulated according to the result of said subtraction.

4. A control loop method, wherein the steps of the method according to claim 1 are repeated after a predefined number of pulses of at least one of said signals has passed.

5. A control circuit for controlling at least one of the speed and the position of an electric motor comprising
a pulse generator for generating a digitally pulsed first signal, whose frequency represents a desired speed of the motor;
input means for a second signal which represents at least one of the current speed and current position of the motor;
means for deriving a control signal from an output of comparing means designed to compare said first signal to said second signal; and
output means outputting said control signal to at least one of the electric motor and a power supply of the motor for controlling at least one of the speed and the position of the motor, characterised in that said input means for said second signal are designed to receive a digitally pulsed signal whose frequency is an encoding of at least one of the motor speed motor position and said comparing means are designed to subtract the number of pulses of said first signal from the number of pulses of said second signal or vice versa.

6. The control circuit according to claim 5, characterised in that said comparing means comprise a digital up and down counter designed to count in the directions up and down and to subtract the number of pulses of said first signal from the number of pulses of said second signal or vice versa by counting the number of pulses of the first signal in the opposite direction from the pulses of the second signal.

7. The control circuit according to claim 5, characterised in that said means for deriving a control signal comprise a pulse width generator designed to modulate a pulse width of the control signal according to a result of said subtraction.

8. The control circuit according to claim 5, characterised in that the control circuit comprises control loop means designed to repeat the steps of the method according to claim 1 after a predefined number of pulses of at least one of the signals have passed.

9. An electric motor, comprising
a sensor for generating a digitally pulsed signal having a frequency representing the actual speed of the motor and
control signal input means,
characterised in that the electric motor comprises a control circuit according to claim 6, having the pulsed signal generated by the sensor at its input means and having connected its output means to the control signal input means or the power supply of the motor.

10. An electric motor comprising a sensor for generating a digitally pulsed signal having a frequency representing the actual speed of the motor and further comprising a control signal input, wherein the electric motor includes a control circuit for controlling at least one of the speed and the position of the electric motor, the control circuit comprising a first input receiving the pulsed signal from the sensor, a pulse generator for generating a digitally pulsed first signal whose frequency represents a desired speed of the motor, a second input receiving a second signal which is a digitally pulsed signal having a frequency representing at least one of the current speed and current position of the motor, a control signal generator generating a control signal in accordance with a comparison of said first signal and said second signal, and an output providing said control signal to at least one of the control signal input or a power supply of the motor for controlling at least one of the speed and the position of the motor, wherein said comparison of said first and second signals is obtained by an up and down counter designed to subtract the number of pulses of said first signal from the number of pulses of said second signal or vice versa by counting the number of pulses of the first signal in an opposite direction from the pulses of the second signal, wherein said control circuit comprises a microprocessor loaded with a computer program with software code sections by which the steps of the method according to claim 1 are effected.

11. A method according to claim 1, wherein said electric motor is a direct current motor.

12. A control loop method according to claim 4, wherein said predefined number of pulses corresponds to one revolution of the motor.

13. A control circuit according to claim 5, wherein said control circuit comprises a microprocessor.

14. A control circuit according to claim 5, wherein said electric motor is a direct current motor.

15. An electric motor according to claim 9, wherein said electric motor is a direct current motor.
